(19) United States
(12) Patent Application Publication
(10) Pub. No.: US 2025/0137904 A1
(43) Pub. Date: May 1, 2025

(54) MECHANICAL RESONATOR WITH LOW LEVEL OF SYMMETRY FOR THE MEASUREMENT OF THE MASS OF INDIVIDUAL PARTICLES

(71) Applicant: CONSEJO SUPERIOR DE INVESTIGACIONES CIENTÍFICAS (CSIC), Madrid (ES)

(72) Inventors: Adrián SANZ JIMÉNEZ, Madrid (ES); José Jaime RUZ MARTÍNEZ, Madrid (ES); Eduardo GIL SANTOS, Madrid (ES); Oscar MALVAR VIDAL, Madrid (ES); Javier TAMAYO DE MIGUEL, Madrid (ES); Montserrat CALLEJA GÓMEZ, Madrid (ES)

(21) Appl. No.: 18/833,667

(22) PCT Filed: Nov. 3, 2022
(86) PCT No.: PCT/EP2022/080711

§ 371 Date: Jul. 26, 2024

(30) Foreign Application Priority Data
Jan. 31, 2022 (EP) 22382080.4

(51) Int. Cl. G01N 15/10

(52) U.S. Cl. CPC G01N 15/10

(57) ABSTRACT

A mechanical resonator with low level of symmetry for the measurement of the mechanical properties of individual particles includes: a resonator element made of an elastic material and adapted for sustaining at least one oscillation mode, and a clamping structure supporting the resonator element. Additionally, all edges of the resonator element are anchored to the clamping structure. The thickness of the resonator element is much smaller than its length and width, such as a membrane. Its mechanical symmetry is N≤2, and its aspect ratio comprised between 1+10*mₐ/M and 100. Further, mₐ is the mass of a particle whose mass is to be measured and M is the mass of the resonator element used to measure it.

### OBJECT OF THE INVENTION

A mechanical resonator with the shape of a rectangular membrane, for the measurement of the mass of individual particles with an aspect ratio between 1.01 and 10, to avoid effects of modes degeneration.

### BACKGROUND OF THE INVENTION

Nanomechanical resonators are playing a fundamental role for the development of new techniques and new technologies for very different applications, ranging from quantum measurements to chemical or biological sensing. In the last decades, nanomechanical resonators have been widely used for mass sensing due to their extremely high sensitivity giving rise to a new type of mass spectrometry named nanomechanical mass spectrometry that has proven to be extremely useful for the mass measurement of macrobiological entities such as proteins, viruses and bacteria, where conventional mass spectrometers really struggle due to the high uncertainty in the mass to charge ratio of such massive particles. Furthermore, nanomechanical mass spectrometry does not require the fragmentation or ionization of the sample and can identify the biological entity with its intact conformation, just by measuring mechanical properties such as the mass or the stiffness of the particle.

The principle of work of nanomechanical mass spectrometry is that the resonance frequencies of the resonator are altered when a particle is adsorbed on the resonator's surface. According to Hooke's law, the vibrational resonance frequency of the resonator is inversely proportional to the squared root of its mass. The adsorption of a particle will cause an increment of the total mass, therefore producing a downshift in frequency. The measurement of these frequency changes allows to obtain a value of the mass of the particle by mean of the following fundamental equation that relates the relative frequency shift with the mass of the adsorbed particle:

$$\frac{Δ f}{{f}_{0}} = - \frac{1}{2} \frac{{m}_{a}}{M} {ψ ( {X}_{0} , {Y}_{0} )}^{2} \qquad ( 1 )$$

Where M is the mass of the resonator, mₐ is the mass of the particle, X₀ and Y₀ are the normalized coordinates of the position of the particle on the resonator's surface and ψ represents the mode shape associated to the vibration frequency f.

Resonators and resonance frequency measurement methods have been improved since the invention of nanomechanical mass spectrometry, with the aim of measuring different types of particles, such as proteins, viruses or bacteria, and increasing their capture efficiency. Nanomechanical resonators can be even designed to measure not only the mass but other mechanical properties like the stiffness or even the shape of the particles. These advances have required a great deal of work on different micro- and nanofabrication techniques, thus entailing a high cost.

One of the most challenging aspects of nanomechanical mass spectrometry is the capture efficiency, to deliver the particles from the original sample (that can be a liquid sample, a surface or simply the air in a room) to the resonator surface.

In order to improve capture efficiency, enormous efforts have been made to focus the particle beam on the smallest possible cross section area. This is a really difficult task for such big masses because it must be done based on aerodynamic principles, not electromagnetic, because the electromagnetic fields necessary to move these kinds of particles at the velocities that they travel through the system would be extremely high and unpractical.

Increasing the resonator capture area also helps to improve capture efficiency. This can be done in two ways, using arrays of resonators working together or basically optimizing the shape of the resonator. The first one is a good solution but requires extremely complex fabrication processes and readout mechanisms not easy to implement. The problem with the second one is that increasing the area of the resonator also decreases the sensitivity, so at the end it must be a compromise between capture efficiency and sensitivity. For this purpose, the optimum shape of the resonator is a plate as thin as possible with as much area as possible, which can be achieved with an aspect ratio as close to one as possible. A common choice is to use simple geometrical forms such as circles, squares or rectangles.

These geometries support different types of modes of vibration depending on the boundary conditions, each one associated to its particular resonance frequency. Note from equation (1) that, in order to calculate the mass of the particle, it is necessary to accurately know the adsorption position and the mode shape associated to the frequency that is being measured. Consequently, during a measurement, the mode shape should not change and if it does, we should know exactly how it changes. If the adsorption position is unknown, which is the most common case, several resonance frequencies must be measured simultaneously in order to mathematically calculate the adsorption position.

The not changing condition of the mode shapes is usually taken for granted in most of the cases because it is well satisfied for structures like cantilevers or double-clamped beams, two of the most popular geometries that are used for sensing applications. However, best geometries to improve capture efficiency are those with an aspect ratio as close to one as possible, cantilevers or double-clamped beams are not the best choices for good capture efficiency.

The problem with a geometry that has aspect ratio close to one is that it usually possesses quasi-degenerate modes, i.e., two different modes that vibrate at very close frequencies. These modes are extremely unstable and just a tiny perturbation like the adsorption of a small particle can make them change drastically. These changes of the vibration modes shape produce undesirable effects on the resonance frequencies that are not considered by equation (1) no longer being possible to apply them to obtain the mass and position of the adsorbed particle.

It is then fundamental to find a compromise in the aspect ratio of the mechanical resonator such that the capture efficiency is as high as possible and at the same time degeneration effects are negligible for the correct calculation of the mass and position of the particle.

A first document PAYANDEHPEYMAN JAVAD ET AL: “Detection of SARS-COV-2 Using Antibody-Antigen Interactions with Graphene-Based Nanomechanical Resonator Sensors”, ACS APPLIED NANO MATERIALS, vol. 4, no. 6, 1 Jun. 2021 (2021 Jun. 1) simulates a graphene-based nanomechanical resonator sensor for SARS-COV-2 detection.

A second document NGUYEN DANH-TRUONG ET AL: “Atomistic simulation of free transverse vibration of graphene, hexagonal SiC, and BN nanosheets”, ACTA MECHANICA SINICA, vol. 33, 132-147 (2017) investigates free transverse vibration of monolayer graphene, boron nitride and silicon carbide by using molecular dynamics finite element method.

A third document SAKHAEE-POUR A ET AL: “Vibrational analysis of single-layered graphene sheets”, NANOTECHNOLOGY, INSTITUTE OF PHYSICS PUBLISHING, BRISTOL, GB, vol. 19, no. 8, 4 Feb. 2008 (2008-02-04) describes A molecular structural mechanics method to investigate the vibrational behavior of single-layered graphene sheets.

None of these three documents introduce a mechanical resonator that is able to measure the mass of individual particles.

In the first document, the authors claim in the abstract that: “identifying the SARS-CoV-2 virus even when the number of the viruses are less than 10 per test”. In the conclusions, the authors claim that: “The results showed that the sensor could detect SARS-COV-2 ranging from 10 to 1000 viruses per test with a passable frequency shift”.

The resonator of the first document is not used to measure the mass of the SARS-CoV-2 virus particles. In this document, the mass of the particles is mentioned in page 6192, where the authors estimate the mass of the SARS-COV-2 virus particles based on the density and size reported for the virus in an article. However, this mass was not measured with the nanomechanical resonator.

Additionally, they claim a small sensitivity, as they detect less than 10 particles per test.

Finally, the first document introduces a resonator whose surface is functionalized with specific antibodies to allocate the SARS-COV-2 virus particles.

In the second and third documents, the resonators are not used to measure the mass of a particle. The second document introduces the eigenfrequencies and eigenmodes of several rectangular-shaped mechanical resonators with different aspect ratios and made of monolayer graphene, boron nitride and silicon carbide, investigated using molecular dynamics fine element method.

The third document introduces the mode shapes and natural frequencies of single-layered graphene sheets, calculated using a molecular structural mechanics method. The mechanical resonators of the second and third documents are not used to detect any particle.

### DESCRIPTION OF THE INVENTION

The present invention describes a mechanical resonator with the shape of a rectangular membrane, for the accurate measurement of the mass of individual particles. The resonator has a wide dynamic range, being able to determine the mass of bacteria, viruses, nanoparticles, etc., very precisely.

As explained before, when mechanical resonators have a geometry that has aspect ratio close to one they possess quasi-degenerate modes. The mechanical symmetry of the structure plays a fundamental role in the existence of quasi-degenerate modes. The mechanical symmetry can be described by an integer N, calculated from the minimum rotation angle ϕ around an axis perpendicular to the sensing area, which gives rise to an analogous mechanical structure, such as N=360/ϕ. Thus, for a rectangle N=2, for an equilateral triangle N=3, for a square N=4 and so on. The most extreme case is of course a disk, which has symmetry of N=∞, i.e., any rotation takes the system to the exact same configuration. Structures with level of symmetry N>2 support degenerate modes and therefore are not the best choice. If the level of symmetry is N≤2, degenerate modes are no longer supported, but quasi-degenerate modes can exist if the aspect ratio is close to 1.

In order to avoid quasi-degenerate modes, the present invention introduces a mechanical resonator with a level of mechanical symmetry of N≤2.

In the invention, an alternative to the mechanical resonators employed so far is presented, exploiting the fact that structures with mechanical symmetry N≤2 do not possess degenerate vibrational modes. The dynamic range of the mechanical resonator is as high as that of previous nanomechanical mass spectrometric works and allows an accuracy in the measurement of mechanical properties equal to or higher than that of the latter. In addition, the particle capture efficiency of the present mechanical resonator is higher than that of previous works and does not require complex manufacturing processes.

Specifically, the resonators of the invention are mechanical resonators that can be applied to mass spectrometry of micro- and nano-entities, which comprise a resonator element made of an elastic material adapted for sustaining at least one oscillation mode, and a clamping structure supporting the resonator element.

Additionally, the mechanical resonator meets the following conditions:
all edges of the resonator element are anchored to the clamping structure,
the thickness of the resonator element is much smaller than its length and width, such as a membrane, which means membranes having a thickness less than or equal to 0.1 times the length of the shorter side of the membrane,
its mechanical symmetry is N≤2, such as an ellipse or a rectangle, and
aspect ratio greater than 1+10*mₐ/M, preferably comprised between 1+10*mₐ/M and 100 (preferably the smallest value in order to maximize capture efficiency), where mₐ is the mass of a particle whose mass is to be measured and M is the mass of the resonator element used to measure it.

We here define the aspect ratio as the ratio between the length of the long characteristic dimension of the resonator Lₓ and the length of the short characteristic dimension of the resonator Ly.

Using resonator elements with aspect ratio comprised between 1+10*mₐ/M and 100 for nanomechanical spectrometry the error coming from quasi-degeneration will not exceed 10%.

The condition for the aspect ratio is expressed as a function of the mass of the particle intended to be deposited on the resonator and the mass of the resonator element itself. This is because the change in the shape of the quasi-degenerate vibrational modes depends on the ratio between these two quantities.

However, a preferred range for the aspect ratio is between 1.01 and 10. An aspect ratio greater than 1.01 for the membrane resonator would lead to calculate the frequency shift caused by the particle deposition with a precision greater than about 1%. An aspect ratio smaller than 10 for the membrane resonator would lead to have a particle capture efficiency of at least the 75% of that of a perfect square.

It should be noted that the mechanical resonator presented in this invention is of great interest for nanomechanical spectrometry not only because of the above mentioned, but also because their geometry causes the frequencies of their vibration modes to be concentrated in a reduced frequency range that will be smaller as the aspect ratio is closer to 1. This is a great advantage for the simultaneous measurement of the frequency of a large number of vibration modes, which increases the accuracy of particle mass measurement.

In the following lines, the effect of particle adsorption on the quasi-degenerate modes of a semi-square membrane are described using a novel theoretical model. The aim of this part is to demonstrate mathematically all the concepts exposed above as well as to bring more insight on the effects of quasi-degeneration on a mechanical resonator used for mass spectrometry.

Consider a resonator element in the shape of a rectangular membrane of length Lₓ, width L_{y} and thickness h, that is centered at the origin of the coordinate system and has its four boundaries clamped to the clamping structure. We define the aspect ratio of the membrane as

$$A R = \frac{{L}_{z}}{{L}_{y}} \geq 1.$$

The out-of-plane vibrations will be determined by the balance between the kinetic and potential energies of the membrane. The kinetic energy can be expressed as a function of the vertical displacement w as follows:

$$T = \frac{1}{2} ρ {hL}_{x}^{2} {\int }_{- 1 / ( 2 AR )}^{1 / ( 2 AR )} {\int }_{- 1 / 2}^{1 / 2} {( \frac{\partial w ( X , Y , t )}{\partial t} )}^{2} dXdY \qquad ( 2 )$$

Where X=x/Lₓ and Y=y/Lₓ are the coordinates normalized to the length of the membrane and ρ is the membrane density.

The potential energy can be split into two different contributions. On one side, the energy due to the bending of the membrane, which is proportional to h³ and on the other side, the energy due to the stress σ inside the membrane due to the fabrication process, which is proportional to h. This stress can be released when the structure has free edges, like cantilever plates for instance. For these cases, this part of the potential energy can be neglected.

In the case of a membrane with all its edges clamped, the stress cannot be released, and because the membranes are usually very thin, the energy due to the stress is much greater than the energy due to bending to the point that it is the bending energy the one that can be neglected. In this demonstration it is assumed that the case is the latter, but the concept can be extended to the general case of bending and stress without any loss of generality. The potential energy of a stressed membrane can be expressed as:

$$U = \frac{1}{2} σ h {\int }_{- 1 / ( 2 AR )}^{1 / ( 2 AR )} {\int }_{- 1 / 2}^{1 / 2} ( {( \frac{\partial w ( X , Y , t )}{\partial X} )}^{2} + {( \frac{\partial w ( X , Y , t )}{\partial Y} )}^{2} ) dXdY \qquad ( 3 )$$

Using equations (2) and (3) the Lagrangian of the system can be formed and the Euler-Lagrange equations can be applied to obtain the equation of motion for the vertical displacement of the membrane. Assuming harmonic motion with angular frequency ω, the final differential equation can be expressed as:

$${λ}^{2} w ( X , Y ) + \frac{{\partial }^{2} w ( X , Y )}{\partial {X}^{2}} + \frac{{\partial }^{2} w ( X , Y )}{\partial {Y}^{2}} = 0 \\ where λ = ω {L}_{x} \sqrt{\frac{ρ}{σ}} . \qquad ( 4 )$$

Assuming that the vertical displacement w(X, Y) must be zero along the four edges of the membrane, equation (4) has infinite solutions that can be represented with a couple of natural numbers (m, n) and that can be expressed as w_{m,n}(X, Y)=Aψ_{m,n}(X, Y), where A is an arbitrary amplitude and ψ_{m,n}(X, Y) is the dimensionless mode shape that is given by:

$${ψ}_{m , n} ( X , Y ) = 2 sin ( m π ( X - \frac{1}{2} ) ) sin ( n π ( YAR - \frac{1}{2} ) ) \qquad ( 5 )$$

Of course, for satisfaction of equation (4), the parameter 2 is not free and will take different values depending on the values of m and n. Thus, for convenience, we will rename the parameter λ to λ_{m,n} and it can be expressed as,

$${λ}_{m , n} = π \sqrt{{m}^{2} + {AR}^{2} {n}^{2}} \qquad ( 6 )$$

The eigenfrequencies are finally given by:

$${f}_{m , n} = \frac{\sqrt{{m}^{2} + {AR}^{2} {n}^{2}}}{2 {L}_{x}} \sqrt{\frac{σ}{ρ}} \qquad ( 7 )$$

Let us now introduce the concept of degeneration. Two or more vibration modes are called degenerate when they have the same frequency. This means that none of them is energetically more favorable than the others. In this case, the mode of vibration can be any linear combination of all the original modes that are degenerate. When two or more modes are degenerate, they are extremely sensitive to small changes because, depending on the perturbation, the degeneration can be broken, and one particular linear combination of the modes will be more energetically favorable than the rest.

In practice, due to small fabrication defects, there is always a particular linear combination that is more energetically favorable. However, even if the frequencies are not exactly the same due to small fabrication defects, a small perturbation can still cause big changes if the energy involve is of the order of the energy difference between the modes. This is the case of quasi-degeneration.

One of the clearest cases of modes degeneration is the couple f_{m,n} and f_{n,m} when the aspect ratio of the membrane is close to 1. As mentioned above, the mode of vibration can be any linear combination of the two original modes and therefore the vertical displacement can be expressed as:

$${w}_{m , n} ( X , Y ) = {A}_{i} {ψ}_{i} ( X , Y ) \qquad ( 8 )$$

Where the index i can take values 1 and 2, Aᵢ are arbitrary amplitudes, ψ₁(X, Y)=ψ_{m,n}(X, Y) and ψ₂(X, Y)=ψ_{n,m}(X, Y), and the Einstein's notation of repeated indices is being used. The kinetic and potential energies of the membrane can be expressed as:

$$T = \frac{{ω}^{2} M}{2} {A}_{i} {A}_{j} {δ}_{i j} \qquad ( 9 )$$

$$U = \frac{h σ}{2 AR} {A}_{i} {A}_{j} {Λ}_{i j} \qquad ( 10 )$$

Where δᵢⱼ is the Kronecker delta,

$$Λ = [ \begin{matrix}{λ}_{m , n}^{2} & 0 \\ 0 & {λ}_{n , m}^{2}\end{matrix} ]$$

and M is the total mass of the membrane. Applying the Rayleigh-Ritz principle, the total kinetic energy must be equal to the total potential energy, giving as a result the equation for the system:

$$( {ω}^{2} M {δ}_{ij} - \frac{h σ}{A R} {Λ}_{ij} ) {A}_{i} {A}_{j} = 0 \qquad ( 11 )$$

The system of equations (11) is homogeneous, therefore the only way to find a solution different than the trivial solution is that the determinant of the system is zero:

$$\vert {ω}^{2} M - \frac{h σ}{A R} Λ \vert = 0 \qquad ( 12 )$$

Where M=MI represents the mass matrix, being I the unity matrix. There are two different solutions for equation (12) which are basically f_{m,n} and f_{n,m} given by equation (7).

Two different scenarios can be distinguished. If AR≠1, for ω=2πf_{m,n}, equation (11) is satisfied for any value of A₁ but only if A₂=0. Similarly, for ω=2πf_{n,m}, equation (11) is satisfied for any value of A₂ but only if A₁=0, there is no degeneration. However, if AR=1, equation (11) is satisfied for any pair of values of A₁ and A₂ and this is basically pure degeneration.

Let us now analyze the effect that particle adsorption produces on these modes. Let assume that there are N particles adsorbed on the membrane surface at N different positions. The kinetic energy of these particles can be expressed as:

$${T}_{a} = \frac{{ω}^{2}}{2} {A}_{i} {A}_{j} Δ {M}_{ij} \qquad ( 13 )$$

Where ΔMᵢⱼ represents the added mass matrix that is given by,

$$Δ M = [ \begin{matrix}{\sum }_{i = 1}^{N} {m}_{a}^{( i )} {{ψ}_{m , n} ( {X}_{0}^{( i )} , {Y}_{0}^{( i )} )}^{2} & {\sum }_{i = 1}^{N} {m}_{a}^{( i )} {ψ}_{m , n} ( {X}_{0}^{( i )} , {Y}_{0}^{( i )} ) {ψ}_{n , m} ( {X}_{0}^{( i )} , {Y}_{0}^{( i )} ) \\ {\sum }_{i = 1}^{N} {m}_{a}^{( i )} {ψ}_{m , n} ( {X}_{0}^{( i )} , {Y}_{0}^{( i )} ) {ψ}_{n , m} ( {X}_{0}^{( i )} , {Y}_{0}^{( i )} ) & {\sum }_{i = 1}^{N} {m}_{a}^{( i )} {{ψ}_{n , m} ( {X}_{0}^{( i )} , {Y}_{0}^{( i )} )}^{2}\end{matrix} ] \qquad ( 14 )$$

Where mₐ⁽ⁱ⁾ and (X₀⁽ⁱ⁾, Y₀⁽ⁱ⁾) are the mass and adsorption position of the ith particle respectively. Assuming that the potential energy is not altered, the new system of equations can be expressed as:

$$( {ω}^{2} ( M {δ}_{ij} + Δ {M}_{ij} ) - \frac{h σ}{A R} {Λ}_{ij} ) {A}_{i} {A}_{j} = 0 \qquad ( 15 )$$

And the equation for the eigenfrequencies now becomes:

$$\vert {ω}^{2} ( M + Δ M ) - \frac{h σ}{A R} Λ \vert = 0 \qquad ( 16 )$$

Now, equation (7) is no longer a solution of equation (16). Instead, the new eigenfrequencies are given by the following expression:

$${f}_{\pm } = \frac{1}{2 π} {( \frac{h σ \vert Λ \vert Tr ( {Δ}^{- 1} ( M + Δ M ) )}{2 AR \vert M + Δ M \vert} ( 1 \pm \sqrt{1 - \frac{4 \vert M + Δ M \vert}{\vert Λ \vert {Tr ( {Δ}^{- 1} ( M + Δ M ) )}^{2}}} ) )}^{1 / 2} \qquad ( 17 )$$

Where Tr represents the trace. The mode shapes associated to these eigenfrequencies can be found calculating the ratio between A₁ and A₂. This ratio can be easily calculated using equation (15) and (16) and is given by,

$${( \frac{{A}_{2}}{{A}_{1}} )}_{\pm } = - \frac{{ω}_{\pm }^{2} Δ {M}_{12}}{{ω}_{\pm }^{2} ( M + Δ {M}_{22} ) \frac{h σ}{A R} {Λ}_{22}} = - \frac{{ω}_{\pm }^{2} ( M + Δ {M}_{11} ) - \frac{h σ}{A R} {Λ}_{11}}{{ω}_{\pm }^{2} Δ {M}_{12}} \qquad ( 18 )$$

The two eigenmodes associated to the eigenfrequencies (17) can then be written for convenience as a function of only one parameter θ so that tan

$$θ = \frac{{A}_{2}}{{A}_{1}} : {ψ}_{\pm } ( X , Y ) = cos {θ}_{\pm } {ψ}_{m , n} ( X , Y ) + sin {θ}_{\pm } {ψ}_{n , m} ( X , Y ) \qquad ( 19 )$$

Equation (19) shows how the eigenmodes change when small particles are adsorbed on the membrane surface. This change depends on the mass and position of the adsorbed particles and increases as the aspect ratio is closer to 1.

It is well known that, for a not degenerate vibration mode, the relative shift in frequency caused by the adsorption of a small particle is given by equation (1) where the mode shape ψ does not change after adsorption. However, for quasi-degenerate modes, equation (1) is not valid anymore and the mode shape changes due to the adsorption. The more is the change on the mode shape, the less accurate equation (1) will be to describe the relative frequency shift.

In order to accurately calculate the change in frequency, equation (17) must be used instead. Importantly, when multiple particles are sequentially adsorbed, in order to calculate the relative frequency shift due to the next particle, the vibration mode shape just before the adsorption must be known.

As the aspect ratio increases from 1, the distance between the two frequencies becomes larger and the change of the mode shapes after the adsorption will be smaller, finally being negligible where equation (1) can be safely applied.

In view of the above, it is also object of the present invention a method for the measurement of the mass of individual particles with a mechanical resonator

Firstly, the method comprises a step of selecting a resonator element which, as previously described, is made of an elastic material and adapted for sustaining at least one oscillation mode.

The resonator element has to be in the shape of a rectangular membrane of length Lₓ, width L_{y} and thickness h, being the width L_{y} its shorter characteristic dimension. Its thickness h must be less than or equal to 0.1 times its width L_{y}, and its aspect ratio has to be comprised between 1.01 and 10.

Secondly, the method comprises the step of anchoring all edges of the resonator element to a clamping structure and arranging a particle whose mass is to be measured on the resonator element.

Finally, the method comprises a step of measuring frequency shifts of the resonator element caused by the particle adhesion, and calculating the mass of the particle mₐ by applying the following equation:

$$\frac{Δ f}{{f}_{0}} = - \frac{1}{2} \frac{{m}_{a}}{M} {ψ ( {X}_{0} , {Y}_{0} )}^{2}$$

where M is the mass of the resonator element (1), X₀ and Y₀ are the normalized coordinates of the position of the particle on the resonator element (1) and ψ is the mode shape associated to the vibration frequency f.

### DESCRIPTION OF THE DRAWINGS

To complement the description being made and in order to aid towards a better understanding of the characteristics of the invention, in accordance with a preferred example of practical embodiment thereof, a set of drawings is attached as an integral part of said description wherein, with illustrative and non-limiting character, the following has been represented:

FIG. 1.—Shows a simplified scheme of the mechanical resonator. The resonator element (1), the clamping structure (2), the long characteristic dimension (3) and the short characteristic dimension (4).

FIG. 2.—Shows values of the parameter θ, that is directly related with the change in the mode shape, during a virtual experiment of 300 randomly distributed adsorptions of E. coli bacteria with a mean mass of 500 fg and a standard deviation of 100 fg on silicon nitride rectangular membrane resonator elements for different aspect ratios of the resonator element, for the degenerate modes (m, n)=(2,1) (a) and b)) and (m, n)=(3,1) (c) and d)). Insets show the state of the mode shape in a particular moment of the virtual experiment.

FIG. 3.—Shows a) Averaged and b) maximum change of 0 per single adsorption as a function of the aspect ratio of the resonator element for the vibration modes (m, n)=(2,1) and (m, n)=(3,1).

FIG. 4.—Shows a), c). Frequencies f₋ and f₊ normalized to the initial frequency as a function of the event number for the degenerate modes (m, n)=(2,1). The solid line shows the exact value of the normalized frequency. The dashed and dot lines show the normalized frequency calculated using the mode shape before adsorption and the mode shape after adsorption, respectively. b), d). Relative frequency shift accounting for the degeneration versus not accounting for degeneration (equation (1)) for all the 300 events, when calculated with the mode shape before adsorption (empty circles) and with the mode shape after adsorption (filled circles). The aspect ratio of the membrane represented in the figures is 1.0001.

FIG. 5.—Shows a), c). Frequencies f₋ and f₊ normalized to the initial frequency as a function of the event number for the degenerate modes (m, n)=(3,1). The solid line shows the exact value of the normalized frequency. The dashed and dot lines show the normalized frequency calculated using the mode shape before adsorption and the mode shape after adsorption, respectively. b), d). Relative frequency shift accounting for the degeneration versus not accounting for degeneration (equation (1)) for all the 300 events, when calculated with the mode shape before adsorption (empty circles) and with the mode shape after adsorption (filled circles). The aspect ratio of the membrane represented in the figures is 1.0001.

FIG. 6.—Shows the dependence of the average normalized frequency shift error, |ε_{f}|ₘₑₐₙ, in % (a) and the maximum value of the normalized frequency shift error, |ε_{f}|ₘₐₓ, in % (b) as a function of the aspect ratio of the membrane resonator. The normalized frequency shift error is defined as:

$${ε}_{f} = \vert [ {( \frac{{f}_{f} - {f}_{0}}{{f}_{0}} )}_{calculated} - {( \frac{{f}_{f} - {f}_{0}}{{f}_{0}} )}_{exact} ] / {( \frac{{f}_{f} - {f}_{0}}{{f}_{0}} )}_{exact} \vert ,$$

where f₀ is the resonance frequency before the particle deposition and f_{f} is the resonance frequency after the particle deposition. The empty circles represent the degenerate modes (m, n)=(2,1) and the filled circles represent the degenerate modes (m, n)=(3,1) in both figures.

FIG. 7.—Shows a) the landing of the 10,000 particles (open circles) in a square membrane resonator with aspect ratio of 1 (black line) and a rectangular membrane resonator of aspect ratio of 10 (grey line). b) Capture efficiency as a function of the aspect ratio of the membrane resonator, from aspect ratio of 1 to aspect ratio of 10.

FIG. 8.—Shows a) Experimental mode maps of the rectangular membrane resonator element with aspect ratio of 1.001 used in the real experiment before deposition of E. coli bacteria with a nanomechanical mass spectrometer system, measured by DHM (Digital Holographic Microscope). b) Theoretical mode maps obtained by fitting the experimental modes to equation (18) to obtain the parameter e for every case.

FIG. 9.—Shows positions of the adsorbed particles in the rectangular membrane resonator element with aspect ratio of 1.001 a) and in the rectangular membrane resonator element with aspect ratio of 8/7≈1.14 b). The white circles represent the real positions of the E. coli bacteria obtained by the optical image in the background. The grey circles represent the positions calculated by the inverse problem algorithm and the numbers represent the jump in chronological order.

FIG. 10.—Shows a) Experimental mode maps of the rectangular membrane resonator element with aspect ratio of 1.001 used in the experiment before deposition of bacteria, measured by DHM. b) Experimental mode maps of the rectangular membrane resonator element with aspect ratio of 1.001 after the deposition of bacteria, measured by DHM where a clear change in the mode shapes can be seen.

FIG. 11.—Shows the landing positions of 10,000 particles of the virtual experiment. The axes are dimensioned in microns. The rectangle at the center represents the rectangular resonator element (400×350×0.05 μm) and the circle at the center represents the circular resonator element (R=211.1 μm and t=0.05 μm) considered in our virtual experiment.

FIG. 12.—Shows a summary of the results obtained in the comparison from the virtual experiment between the rectangular membrane resonator element (400×350×0.05 μm) and the circular membrane resonator element (R=211.1 μm and t=0.05 μm).

FIG. 13.—Shows the probability density functions of the mass of the first particle to land on each resonator element. a) Probability density function of the mass of the first particle to land on the rectangular resonator element ((400×350×0.05 μm) and b) probability density function of the mass of the first particle to land on the circular membrane resonator element (R=211.1 μm and t=0.05 μm).

FIG. 14.—Comparison between the probability density functions of the mass for the captured particles calculated by the inverse problem and their real masses. a) Probability density functions of the mass of the 593 particles captured by the rectangular resonator (straight line) and the real masses of these particles (filled curve). b) Probability density functions of the mass of the 592 particles captured by the circular resonator (straight line) and the real masses of these particles (filled curve).

### PREFERRED EMBODIMENT OF THE INVENTION

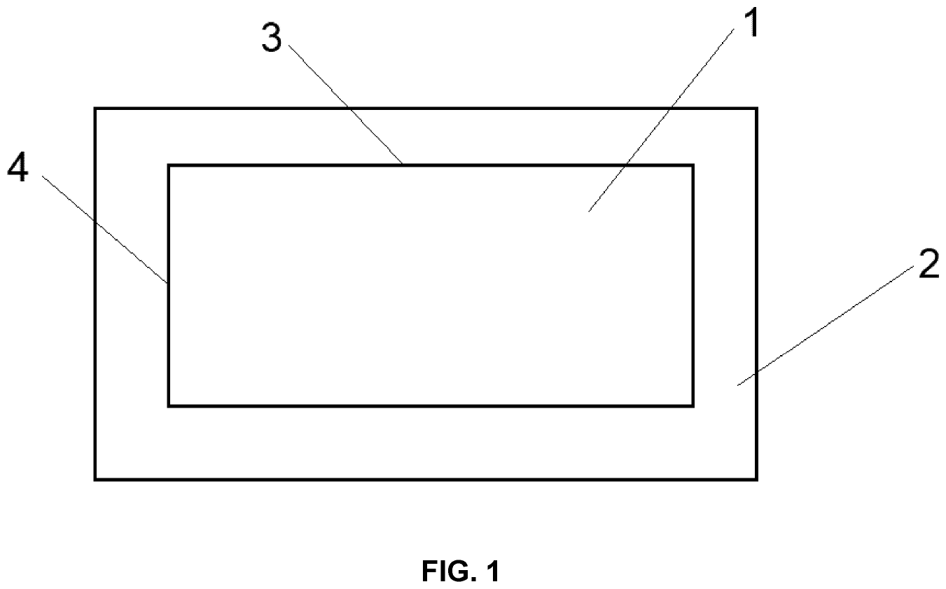

A preferred embodiment of the mechanical resonator with the shape of a rectangular membrane is described below, with the aid of FIGS. 1 to 14.

The mechanical resonator comprises a resonator element (1) made of an elastic material and adapted for sustaining at least one oscillation mode, and a clamping structure (2) supporting the resonator element (1). The mechanical resonator also comprises a measuring module, connected to the resonator element (1), and configures to measure one or more oscillation modes.

Additionally, the mechanical resonator meets the following conditions:
all edges of the resonator element (1) are anchored to the clamping structure (2),
the thickness of the resonator element (1) is much smaller than its length and width, such as a membrane,
its mechanical symmetry is N≤2, such as an ellipse or a rectangle, and
aspect ratio greater than 1+10*mₐ/M, preferably comprised between 1+10*mₐ/M and 100, more preferably comprised between 1+10*mₐ/M and 10, and even more preferably comprised between 1+10*mₐ/M and 1.5, where mₐ is the mass of an analyte whose mass is to be measured and M is the mass of the resonator element (1) used to measure it.

The condition for the aspect ratio is expressed as a function of the mass of the analyte intended to be deposited on the resonator and the mass of the resonator element (1) itself. This is because the change in the shape of the degenerate vibrational modes depends on the ratio between these two quantities.

More preferably, the resonator element (1) meets the following conditions:
It has the shape of a rectangular membrane of length Lₓ, width L_{y} and thickness h, being the width L_{y} its shorter characteristic dimension (4), and
it has an aspect ratio in the range between 1.01 and 10.

The aspect ratio is comprised in the range 1.01 and 10. An aspect ratio greater than 1.01 leads to the calculation of the frequency shift caused by the particle deposition with a precision greater than about 1%. And the aspect ratio smaller than 10 for the membrane resonator leads to keep the particle capture efficiency greater than at least the 75% of that of a perfect square.

In order to give a bit of insight of the phenomenon, virtual experiments of E. coli bacteria adsorptions have been performed on rectangular silicon nitride resonator elements (1) with aspect ratio very close to 1.

A total of 300 randomly distributed adsorptions were generated with masses following a normal distribution with mean of 500 fg and standard deviation of 100 fg that are typical values for E. coli bacterial cells. The width of the resonator element (1) was fixed to 250 μm and the aspect ratio was varied from 1.0001 to 1.1585.

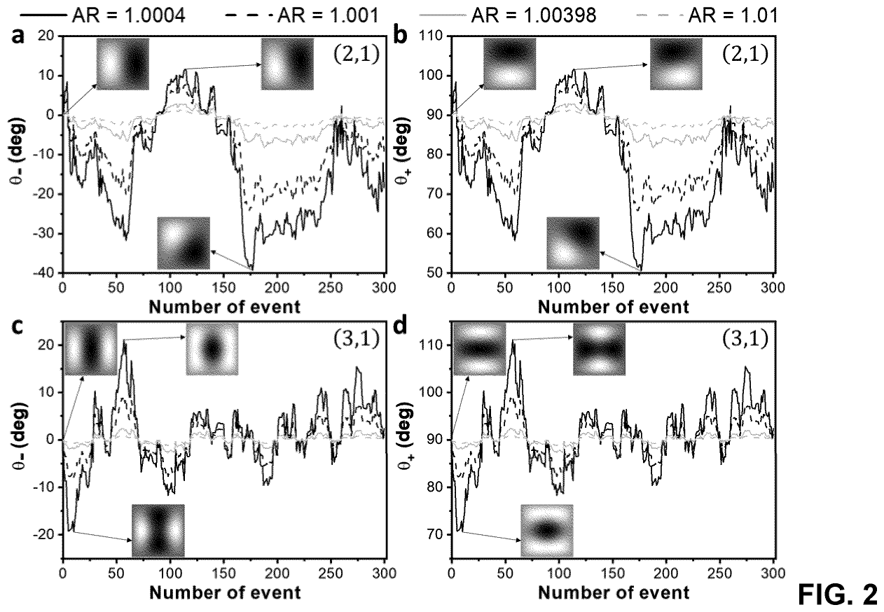

FIG. 2 shows the values of the parameters θ₊ and θ₋ as the different adsorptions take place for the quasi-degenerate modes (m, n)=(2,1) and (m, n)=(3,1) for different aspect ratios. It can be observed that as the aspect ratio increases, the variation of the mode shape becomes smaller. However, if the aspect ratio is very close to 1, after few adsorptions, the mode shape can change dramatically from its original form.

Of course, these are random curves that depend on the adsorption positions, but they clearly show how the mode shapes can change in a single experiment with just a few adsorption events. For instance, for the case of (m, n)=(2,1) and aspect ratio of 1.0004, after around 60 events, the parameter θ has decreased around 30 degrees, then it goes back to its initial value after around 60 events more, and finally takes the opposite value, increasing around 30 degrees after 150 events more.

Something similar occurs for the case of (m, n)=(3,1), but in this case the change is even quicker and after around 20 events the parameter θ has decreased around 40 degrees changing the mode shape drastically. Although these curves seem to be rather random, there are certain values that can show a clear dependence on, for example, the aspect ratio of the resonator element (1).

It would be interesting to see the dependence of the absolute variation of the parameter θ as a function of the aspect ratio of the resonator element (1) in order to see at which aspect ratio it is safe to use the classical equation (1).

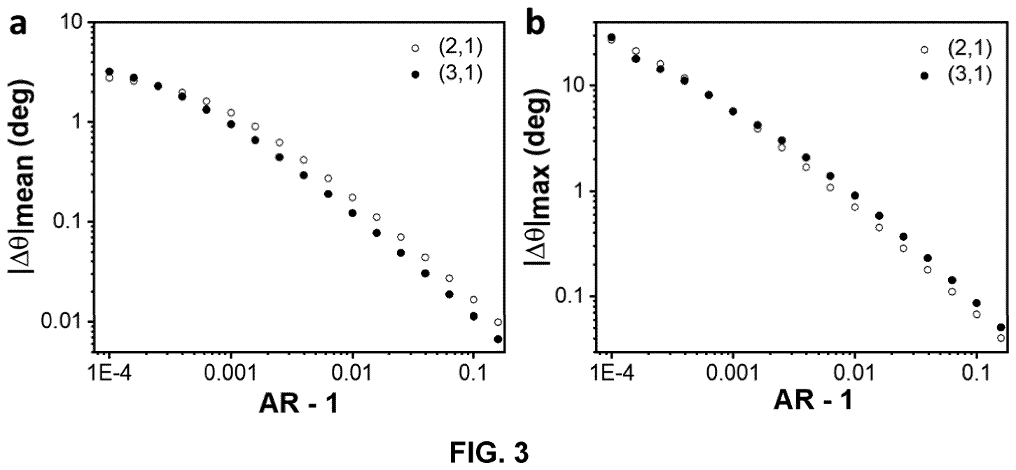

In this sense, the average change of 0 per event as a function of the aspect ratio has been calculated, and the result is shown in FIG. 3a.

It must be noted that the values shown in FIG. 3a are average values, there are adsorptions that produce bigger changes and adsorptions that produce much smaller changes. Of course, an average change of 40 per event does not mean that after 300 events the total change will be 30040, the randomness of the adsorption positions will make the value of 0 fluctuate in a much narrower range.

In FIG. 3b the maximum change of 0 produced by one adsorption event is shown. It is quite remarkable that for an aspect ratio of 1.0001 a change of almost 100 degrees was produced by just a single adsorption. In order to use equation (1) safely, we must be sure that the target mass will not produce significant changes in the mode shape.

Now, let us consider that the mode shape at every time can be measured, if we would like to approximate the relative frequency shift by equation (1) we should choose either to use the mode shape before the adsorption or after the adsorption. For either of these choices, we would be committing some error.

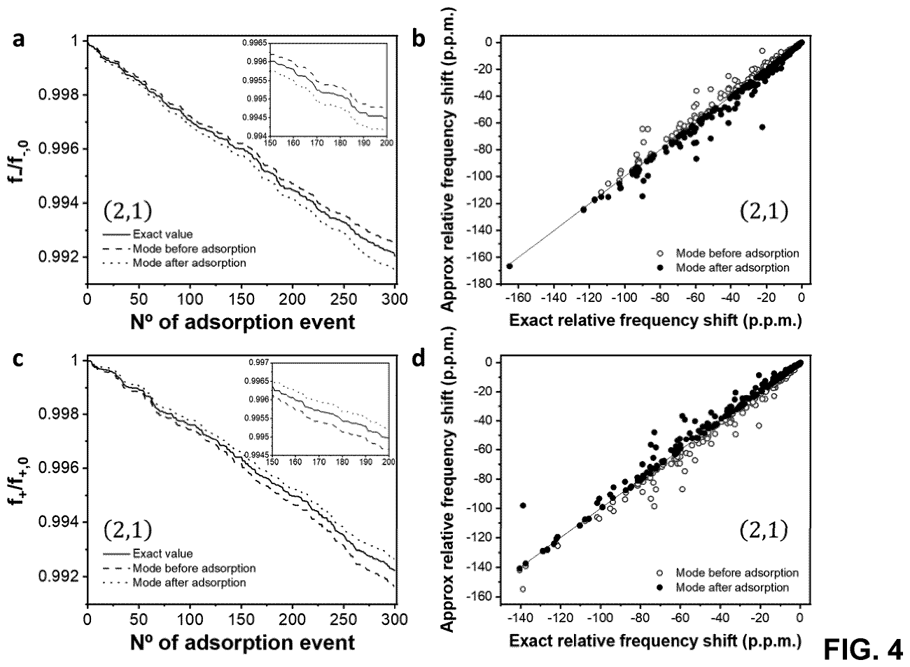

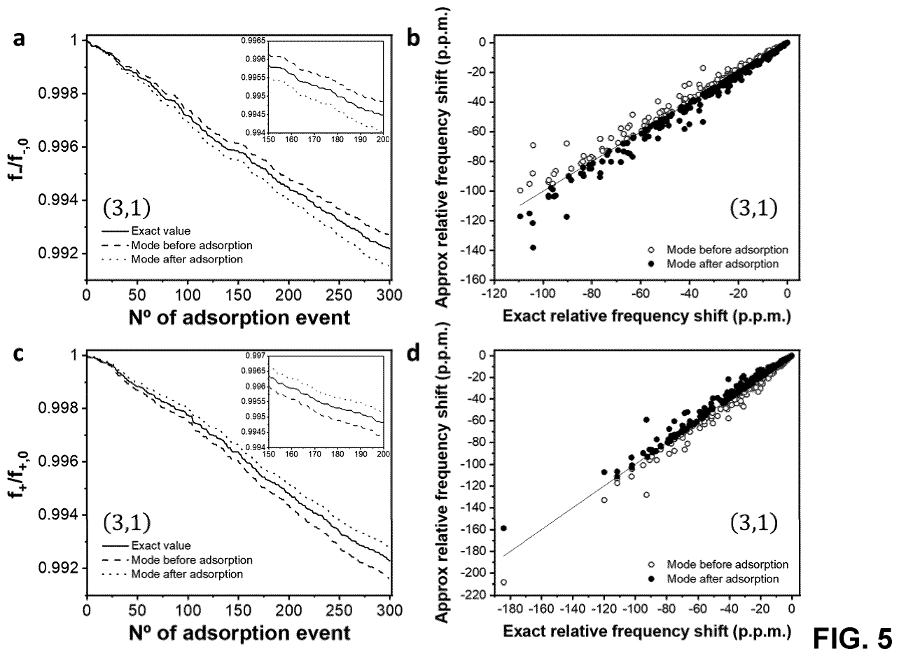

FIGS. 4 and 5 show the error committed by using equation (1) in order to calculate the relative frequency shift for the modes (m, n)=(2,1) and (m, n)=(3,1) respectively for an aspect ratio of 1.0001.

For some adsorptions, the error is very small while for other adsorptions the error is huge, it depends on the adsorption position and on how much the parameter e changes. Note how, if the mode shape is used before the adsorption in the approximation, the relative frequency shift is underestimated for f₋ while it is overestimated for f₊.

Of course, these values have been calculated for a resonator element (1) with an aspect ratio extremely close to 1, and as shown in FIG. 3, the error in the approximation of equation (1) will decrease as the aspect ratio increases, but it is clear that, in order to be precise in the calculation of the frequency, equation (17) must be used.

The mass and position of the adsorbed particle is calculated from the relative frequency shifts by means of the so-called inverse problem. The inverse problem is a probabilistic problem that is computationally quite expensive. The feasibility of the inverse problem algorithm relies on the simplicity of equation (1). If equation (17) were used instead of equation (1), the added complexity will make the inverse problem algorithm unfeasible. Therefore, mechanical resonators with the shape of a rectangular membrane with aspect ratio between 1.01 and 10 will lead to the precise calculation of the mass of individual particles without the expense of computationally time-consuming algorithms.

From the same virtual experiment of the FIG. 2, we have estimated the error committed in the frequency shift calculation caused by the particle deposition. In order to quantify this error, we define the normalized frequency shift error: ε_{f}. This parameter is defined as follows:

$${ε}_{f} = \vert [ {( \frac{{f}_{f} - {f}_{0}}{{f}_{0}} )}_{calculated} - {( \frac{{f}_{f} - {f}_{0}}{{f}_{0}} )}_{exact} ] / {( \frac{{f}_{f} - {f}_{0}}{{f}_{0}} )}_{exact} \vert$$

where f₀ is the resonance frequency before the particle deposition and f_{f} is the resonance frequency after the particle deposition.

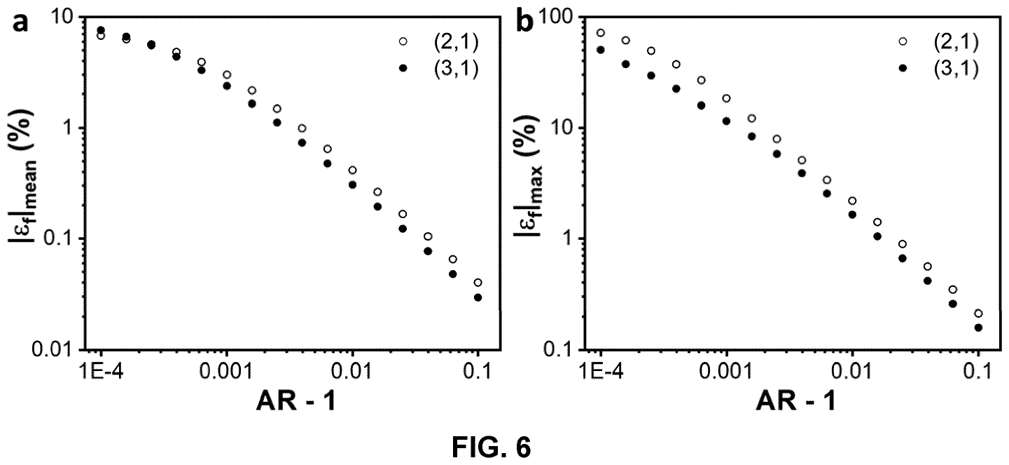

It compares the frequency shift calculated by equation (1) and the exact frequency shift caused by the adhesion of the particle. FIG. 6a shows the average value of the normalized frequency shift error, |εf|mean, as a function of the aspect ratio for the modes (m,n)=(2,1) (open circles) and (m,n)=(3,1) (filled circles).

As we can see, for a membrane aspect ratio greater or equal than our inferior limit (1.01), the mean error committed in the frequency shift calculation is smaller than 1%. FIG. 6b shows the maximum value of the normalized frequency shift error, |εf| max, as a function of the aspect ratio. As we can see in this figure, the maximum error committed in the frequency shift calculations for a membrane aspect ratio of 1.01 is around 1%. Therefore, we estimate that an aspect ratio greater than 1.01 allows to calculate the frequency shift caused by a particle with a very high precision (˜1%).

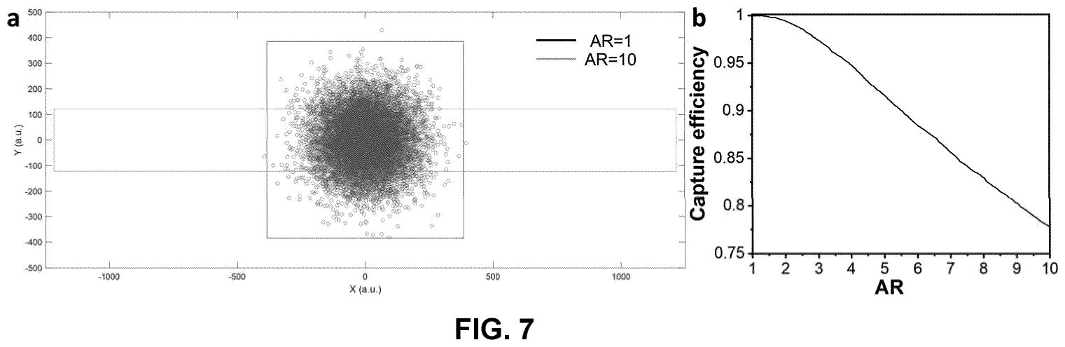

Another virtual experiment has been made. In this virtual experiment, we generate 10,000 particle depositions. The positions of these particles are random and follow a normal distribution in two dimensions, the typical behaviour of the particles' landing positions in nanomechanical spectrometry. FIG. 7a shows the positions of these particles (open circles in grey) where we have defined the normal distributions with mean at the origin of coordinates (0,0) and with a standard deviation of 100. Notice that these are arbitrary units and similar results can be found with other values.

We can define a circle that contains all the particles, which will have a radius given by the distance between the farthest particle from the origin and the origin. Then, we define a square resonator (aspect ratio of 1) with the same capture area than this circle, which is showed by the black line of FIG. 7a. As we can see, this square contains almost the 10,000 particles.

Finally, we have defined membrane resonators with an aspect ratio between the square (aspect ratio of 1) and a rectangle with aspect ratio of 10, changing the values of the long characteristic dimension Lx and the short characteristic dimension Ly so that the resonator area is kept constant. The grey line of FIG. 7a represents the shape of a resonator with aspect ratio of 10. Notice that the area of the square resonator and the area of the resonator with aspect ratio of 10 is the same.

In FIG. 7b, we show the dependence of the particle capture efficiency as a function of the aspect ratio. We can see that, when the aspect ratio is higher than 10, the particle capture efficiency is around 25% worse than that of a perfect square. Therefore, we consider that the superior limit of our membrane resonators shall be 10, in order to keep the particle capture efficiency at least 75% of that of a square resonator with aspect ratio equal to 1.

Finally, real experiments performed with a nanomechanical mass spectrometer system of a few adsorptions of E. coli bacteria on a resonator element (1) with aspect ratio of 1.001 and also on a resonator element (1) with aspect ratio of 8/7≈1.1428, high enough to avoid degeneration, have been performed.

It has been seen how the inverse problem fails to calculate the correct positions of the particles for the rectangular membrane resonator element (1) with aspect ratio of 1.001 while it was very efficient for the resonator element (1) with no degeneration. For both cases, the mode shapes of the membrane with a DHM microscope have been measured before starting the experiments and those modes were used later to obtain the positions of the particles using the inverse problem algorithm with equation (1).

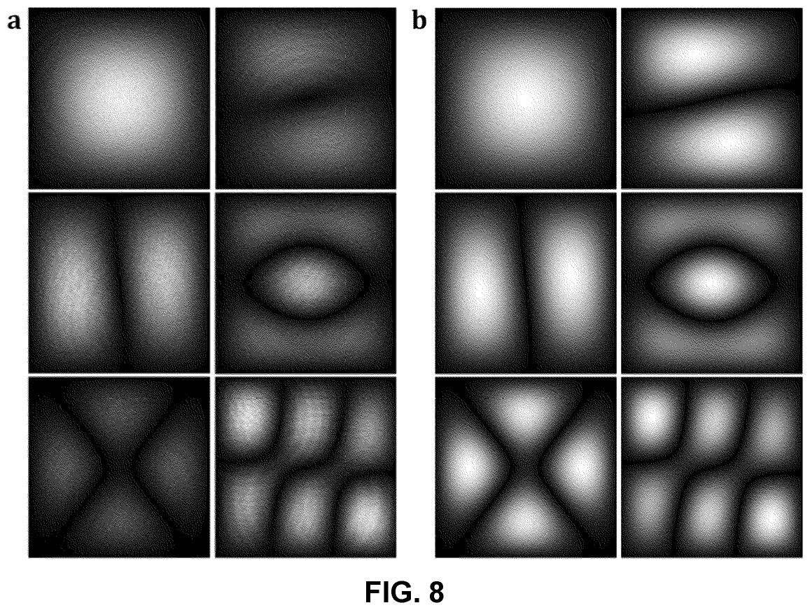

In FIG. 8, we can see the experimental modes and the theoretical ones after fitting to equation (19) to obtain the parameter θ in each case, for the rectangular membrane resonator element (1) with aspect ratio of 1.001 case. Notice that the modes of the rectangular membrane resonator element (1) with aspect ratio of 1.001 differ significantly from the modes of a high aspect ratio resonator element (1), where the modes show no degeneration. FIG. 8a shows the vibrational modes tracked in the experiment, from top to down and from left to right, we show the first, second, third, fifth, sixth and eighth modes.

And FIG. 8b represents the mode shapes calculated with our analytical model, where we fit the shapes to find the values of the 0, parameter for the second, third, fifth, sixth and eighth modes. From top to down and from left to right, we show the first, second, third, fifth, sixth and eighth modes.

Notice that our analytical model fits the mode maps perfectly (FIG. 8b) and allows to precisely obtain the parameter θ of the equation (19).

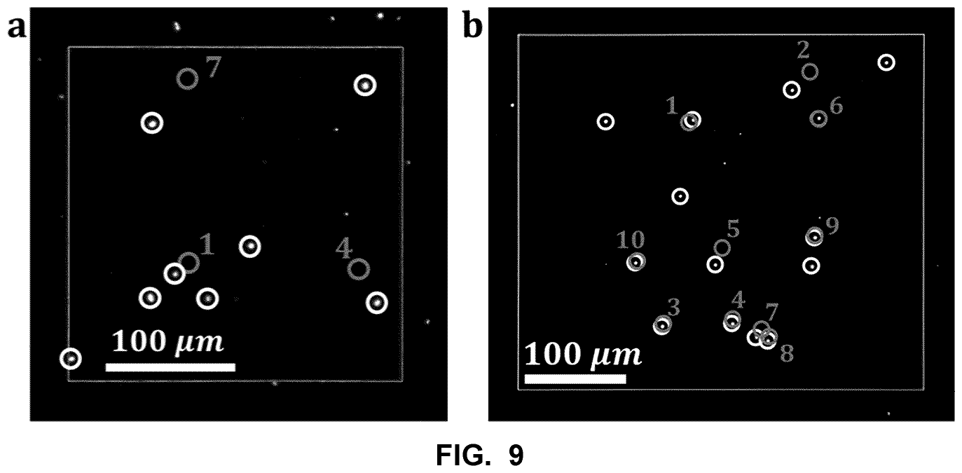

In FIG. 9, it can be seen the real positions of the particles measured by means of an optical microscope in dark field mode (white circles) and the positions calculated by the inverse problem (gray circles).

For the case of the rectangular membrane resonator element (1) with aspect ratio of 1.001 (FIG. 9a), a total of 8 jumps were detected. Although 6 modes have been tracked simultaneously, for some of the jumps, the last mode was lost by the PLL (Phase-locked loop system) and therefore, for these jumps, only 5 modes were used in the inverse problem calculation.

This is actually another drawback of using resonator element (1) with quasi-degenerate modes, the peaks of the quasi-degenerate modes are too close and sometimes it is difficult to track them correctly. Only three of the 8 jumps gave a solution in the inverse problem and only the first one gave an accurate position. This is because we were using the mode shapes measured before the experiment, and probably after the first adsorption they changed enough so that the inverse problem gave no solution or inaccurate solutions for the rest of the particles.

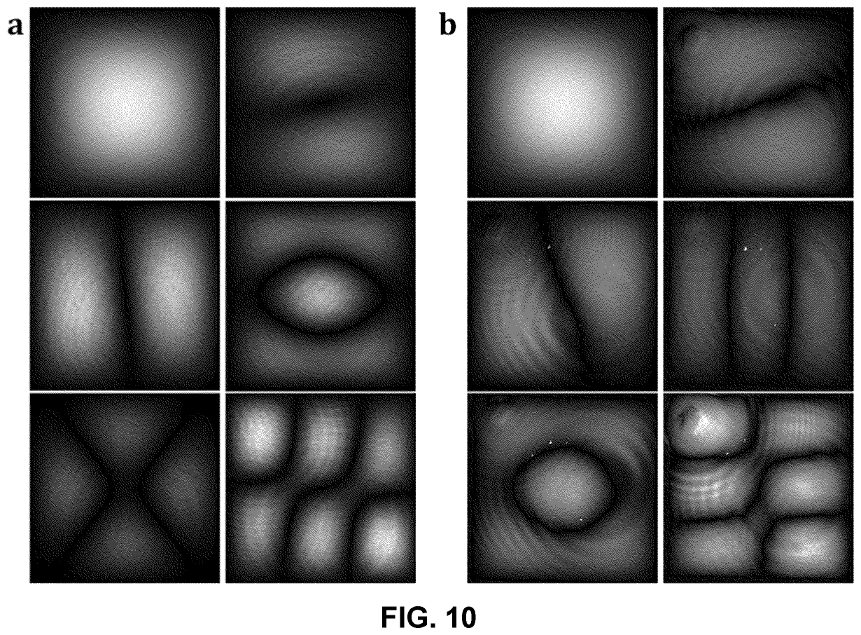

Indeed, in FIG. 10 it can be seen how the mode shapes changed after the experiment. This figure shows the experimental mode maps measured before the deposition of bacteria (FIG. 10a) and after the deposition (FIG. 10b). It is clearly seen that the quasi-degenerate modes of the rectangular membrane resonator element (1) with aspect ratio of 1.001 (258.5×258.3×0.054 μm dimensions) change upon the deposition of E. coli bacteria. The bacteria induce changes in the parameter θ of equation (19), sometimes large enough changes to change the sorting of the modes by resonance frequency. All these changes hinder the calculation of the correct landing position of the bacteria, and so the determination of the mass of these particles.

On the other hand, for the rectangular membrane resonator element with aspect ratio of 8/7≈1.14 (1) (FIG. 9b), a total of 12 jumps were detected during the experiment and 10 of them were successfully calculated by the inverse problem. In this experiment, two of the jumps occurred almost simultaneously and therefore the position of these two particles could not be calculated by the inverse problem because the time resolution was not high enough. The improvement obtained using a rectangular resonator element (1) with aspect ratio of ˜1.1428 in the percentage of successfully particles calculated by the inverse problem and also in the accuracy of the position calculated is evident, proving the concept of the invention.

What is more, we have compared the performance of a rectangular resonator element (1) to the performance of a circular resonator element (1) for the measurement of the mass of individual particles. Both resonator element (1) are made of the same elastic material and are adapted to sustain at least one oscillation mode. Both resonator elements (1) are attached to a clamping structure (2) supporting the resonator element (1), wherein the resonator element (1) meets the following conditions:
all their edges are anchored to the clamping structure (2), and
their thickness is less than or equal to 0.1 times the length of the shorter characteristic dimension (4) of the resonator element (1).

Nevertheless, the resonator elements (1) differ in their aspect ratio, which is the ratio between the length of the long characteristic dimension (3) and the length of the short characteristic dimension (4).

While the aspect ratio of the rectangular resonator element (1) considered here is 8/7≈1.1428, in between the range of 1.01-10, the aspect ratio of the circular resonator element (1) is, by definition, 1.

Here we perform a virtual experiment, where we simulate the nebulization of 10,000 particles. These particles have masses similar to Escherichia coli bacteria, which we have simulated as a normal distribution with mean 500 fg (1 fg=10⁻¹⁵ g) and standard deviation of 120 fg.

This virtual experiment intends to simulate one of the real experiments performed in a nanomechanical mass spectrometer, which is the experimental setup for measuring the masses of individual particles.

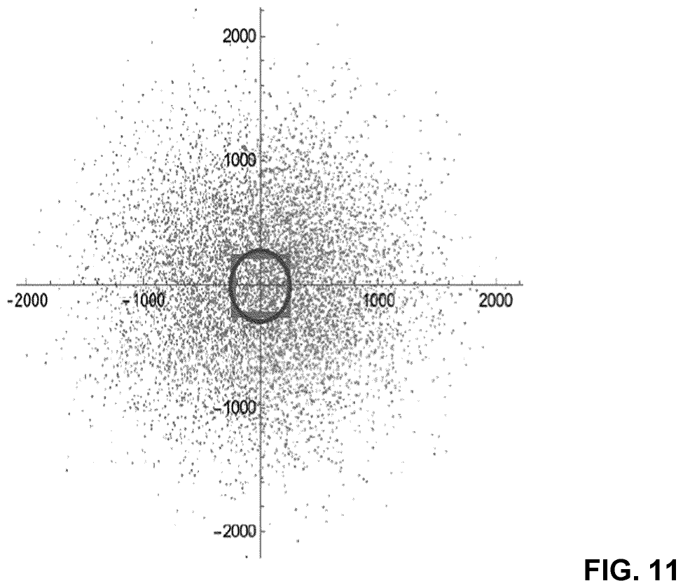

FIG. 11 shows the landing positions of the 10,000 particles (gray dots). The dimensions of the horizontal and vertical axes are in microns. We have simulated that the 10,000 particles land on an area slightly higher than 1 mm². The rectangle at the center of the FIG. 11 shows the rectangular membrane of the resonator element (1) considered in this text and the circle at the center of the graph shows the circular membrane of the resonator element (1).

The rectangular resonator element (1) considered here has the following dimensions: 400×350×0.05 μm, and the circular membrane resonator element (1) has a radius of 211.1 μm and the same thickness than that of the rectangular membrane resonator element (1), 0.05 μm. Both resonator elements (1) have the same capture area, which is 0.14 mm², which will allow making a proper comparison between them. Both resonator elements (1) are made of the same elastic material, silicon nitride.

In order to make a proper comparison, here we will consider the shifts in the resonance frequency of the same number of vibration modes for both resonator elements (1), six vibration modes. For the case of the rectangular membrane resonator element (1), the six modes will be the first six modes by their order in resonance frequency. In the case of the circular membrane resonator element (1), we must only consider the first six axisymmetric vibration modes by their order in resonance frequency.

We shall not consider other vibration modes, different from axisymmetric modes, in this discussion because these are the only vibration modes that do not change their shape upon landing of the particles. As it has been explained before, the change in the mode shape upon adhesion of the particle leads to big uncertainties in the determination of the mass of the particles.

Additionally, here we will consider that the frequency noise for the different six vibration modes is the same for both membrane resonators, and are: 0.739, 0.782, 0.831, 0.784, 0.913 and 0.770 p.p.m. (parts-per-million), for the six modes, respectively. The last frequency noises are in the typical scale for real measurements with ultrathin membrane resonators in low vacuum (˜0.1 mbar). Finally, the minimum resolution fixed for the inverse problem for both membrane resonators will have the same spatial and mass resolution, which will be 70 nm of spatial resolution and 0.7 fg of mass resolution.

Notice that the dimensions of the membranes of the resonator elements (1), the noise for the resonance frequencies and the spatial and mass resolutions have been fixed to make a proper numerical comparison. These parameters may be changed without alter the qualitative details of this comparison, as long as the aspect ratios of the rectangular and circular membrane resonator elements (1) are kept. Similar results can be found when comparing circular membranes resonator elements (1) and rectangular membranes resonator elements (1) with aspect ratios between 1.01 and 10.

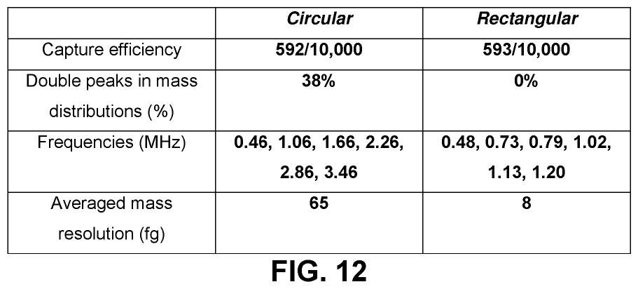

Table in FIG. 12 summarizes the results of the virtual experiment. The first row shows the capture efficiency of both resonator elements (1). As we can see, both capture efficiencies are very similar, 592 particles for the circular membrane resonator element (1) and 593 particles for the rectangular membrane resonator element (1), which is because the capture areas of both resonator elements (1) are the same. The second row refers to the percentage of double peaks that are present in the mass distributions.

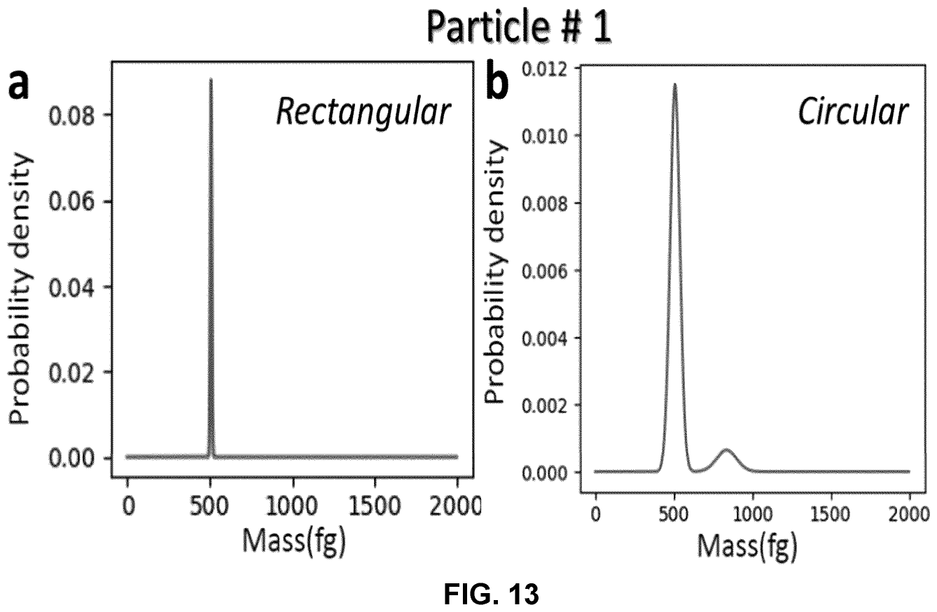

FIG. 13 shows the probability density functions (PDF) of the mass of the first particle to land on each resonator. Particularly, FIG. 13a shows the PDF of the mass of the first particle that adheres on the rectangular resonator element (1), where one peak at ˜500 fg (the mean mass of E. coli particles) may be seen.

FIG. 13b shows the PDF of the mass of the first particle that adheres on the circular resonator element (1), where two peaks are shown: one at ˜500 fg (the mean mass of E. coli particles) and other peak that extends further than ˜800 fg. The larger mass peak is out of the normal distribution of masses of the particles and the smaller mass peak agrees with the expected mass, but shows a much higher standard deviation than the mass peak of the rectangular membrane resonator element (1) of FIG. 13a.

Thus, the circular membrane resonator element (1) shows more uncertainty in the determination of the particles' mass, compared to the rectangular membrane resonator element (1). The latter is shown not only because the resolution of the mass is smaller for the circular membrane resonator element (1), but also because the 38% of the measured masses are double-peaked. Meanwhile, in the case of the rectangular membrane resonator element (1), none of the 593 particles shows a double peak in its mass PDF.

The third row of the table in FIG. 12 refers to the resonance frequencies of the six vibration modes measured in this virtual experiment. It can be seen that the resonance frequency of the first vibration mode is similar to both membrane resonator elements (1), 0.46 MHz for the circular membrane resonator element (1) and 0.48 MHz for the rectangular membrane resonator element (1). Nevertheless, the resonance frequency of the sixth vibration mode measured in this virtual experiment is almost 3 times larger in the case of the circular membrane resonator element (1), 3.46 MHz for the circular membrane resonator element (1) and 1.2 MHz for the rectangular membrane resonator element (1). The latter may be seen as a clear disadvantage of the circular membrane resonator elements (1) with respect to the rectangular membrane resonator elements (1), because the higher the resonance frequency of the vibration modes, the more bandwidth the electronics of the measurement system needs.

The electronics of the measurement system, whether the system is based on optics or electric means, are limited in frequency, i.e. they are able to measure frequencies up to a certain value. In the case of the rectangular membrane resonator element (1), the measurement of the six resonance frequencies requires electronics with smaller bandwidth than for the case of the circular membrane resonator elements (1), which leads to avoid high-cost and complex readout measurement systems.

The fourth row of the table in FIG. 12 refers to the averaged mass resolution of the particles for both membrane resonator elements (1). The mass resolution of one particle is defined as the standard deviation of its mass PDF. Therefore, the averaged mass resolution is the mean of the standard deviations of all the captured particles by each resonator element (1).

In the case of the circular membrane resonator element (1), the averaged mass resolution is 65 fg and in the case of the rectangular membrane resonator element (1) is 8 fg, i.e. more than 8 times smaller. The latter leads to conclude that the rectangular membrane resonator elements (1) are more than eight times more precise than the circular membrane resonator elements (1), in average, in the mass determination of the particles.

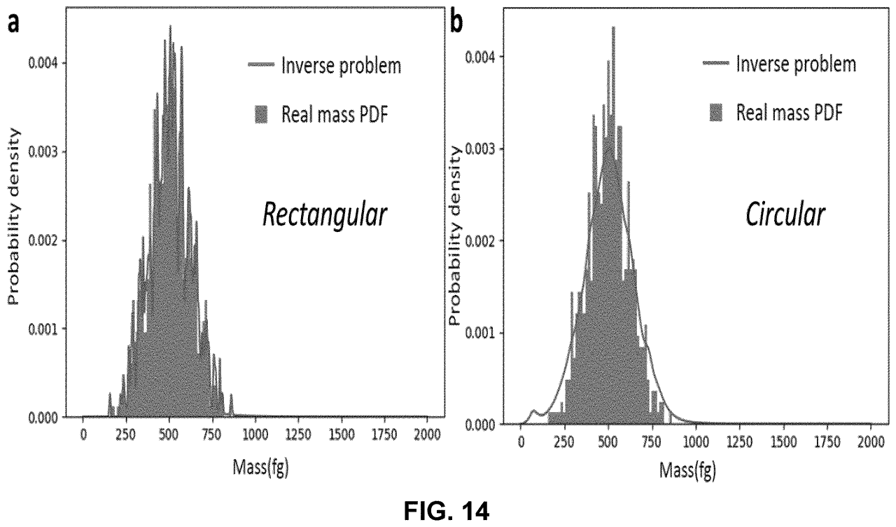

FIG. 14 shows the comparison between the real masses of the particles captured by the resonator elements (1) (filled curve) and the PDF of the masses calculated from the resonance frequency shifts (straight line), which we call as ‘inverse problem’ since we have resolved a so-called inverse problem to obtain the mass PDF.

FIG. 14a shows the comparison of the 593 particles captured by the rectangular membrane resonator element and FIG. 14b shows the comparison of the 592 particles captured by the circular membrane resonator element.

We can clearly see that the rectangular membrane is much more precise in the mass determination than the circular membrane resonator element (1). Although the circular membrane resonator element (1) succeeds in estimating the real mass of the particles, the rectangular membrane resonator element (1) leads to a much more precise calculation of the particles' masses.

The latter is clearly because the rectangular membrane resonator element (1) presents a significantly better mass resolution than that of the circular membrane resonator element (1), not only because the standard deviations of the mass PDFs are smaller for the case of the rectangular membrane resonator element (1), but because the circular membrane resonator element (1) shows a high percentage of double-peaked PDFs (38%).

To sum up, we have performed a virtual experiment where 10,000 particles land on a surface of around 1 mm², with conditions very similar to what we find in our nanomechanical mass spectrometers. These particles have masses similar to the mass of an Escherichia coli bacterial cell. Almost 600 of these particles adhere to the surface of a circular membrane resonator element (1) and a rectangular membrane resonator element (1), both with the same capture area: 0.14 mm².

The aspect ratio of the circular membrane resonator element (1) is, by definition, equal to 1, and the aspect ratio of the rectangular membrane resonator element (1) considered here is ˜1.1428, which lies in between the range of [1.01,10].

When each of these 600 particles accrete on the resonator elements (1), the resonance frequencies associated to their normal vibration modes change. The measurement of these changes may lead to the measurement of the mass of the particle. Here, we have compared the performance of a circular membrane resonator element (1) with the performance of a rectangular membrane resonator element (1) for measuring the mass of these particles.

We have considered the same number of modes tracked: 6, the same frequency noise for the different tracked resonance frequencies and the same minimum spatial and minimum mass resolutions for both resonators.

With the results obtained for each resonator element (1), we conclude that the rectangular membrane resonator elements (1) are more precise mechanical resonators for the measurement of the mass of individual particles. Moreover, the resonance frequencies of the vibration modes used for measuring the mass of the particles are distributed on a smaller bandwidth compared to the circular membrane resonator elements (1), which avoids high cost and complex readout systems.

Hence, the use of rectangular membrane resonator elements (1) with aspect ratios between 1.01 and 10 leads to a more precise characterization of the mass of individual particles and the mass of a particles' ensemble.

1. A mechanical resonator, for the measurement of the mass of individual particles, that comprises:
a resonator element, being a rectangular membrane of length Lₓ, width L_{y} and thickness h, wherein width L_{y} is a shorter characteristic dimension, being made of an elastic material and adapted for sustaining at least one oscillation mode, and
a clamping structure supporting the resonator element,
wherein:
all edges of the resonator element are anchored to the clamping structure,
the thickness h of the resonator element is less than or equal to 0.1 times the width L_{y}, and
an aspect ratio of the resonator element is comprised between 1.01 and 10.

2. The mechanical resonator of claim 1, wherein the aspect ratio of the resonator element is between 1.01 and 1.5.

3. The mechanical resonator of claim 1, further comprising a measuring device connected to the resonator element and configured to measure one or more oscillation modes.

4. A method for measurement of mass of individual particles with a mechanical resonator, that comprises the steps of:
selecting a resonator element made of an elastic material and adapted for sustaining at least one oscillation mode, wherein:
the resonator element is a rectangular membrane of length Lₓ, width L_{y} and thickness h, wherein width L_{y} is a shorter characteristic dimension,
the thickness h of the resonator element is less than or equal to 0.1 times the width L_{y}, and
an aspect ratio of the resonator element is between 1.01 and 10
anchoring all edges of the resonator element to a clamping structure,
arranging on the resonator element a particle whose mass is to be measured,
measuring frequency shifts of the resonator element caused by the particle arranged, and
calculating the mass of the particle arranged, mₐ, by applying the following equation:
$$\frac{Δ f}{{f}_{0}} = - \frac{1}{2} \frac{{m}_{a}}{M} {ψ ( {X}_{0} , {Y}_{0} )}^{2}$$
where M is a mass of the resonator element, X₀ and Y₀ are normalized coordinates of a position of the particle on the resonator element and ψ is a mode shape associated to a vibration frequency f.

5. The method of claim 4, wherein the aspect ratio is between 1.01 and 1.5.
